(19) United States
(12) Patent Application Publication
(10) Pub. No.: US 2015/0141118 A1
(43) Pub. Date: May 21, 2015

(54) SYSTEM AND METHOD OF VIDEO GAMING THAT PROVIDES A GAME OF CHANCE

(71) Applicant: 3OAK Gaming Inc., Quebec (CA)

(72) Inventors: Mikael Lefebvre, Quebec (CA); Daniel Paquet, Quebec (CA); Martin Rheaume, St-Nicolas (CA); Jean-Rémy Horth, Quebec (CA)

(21) Appl. No.: 14/530,927

(22) Filed: Nov. 3, 2014

Related U.S. Application Data
(60) Provisional application No. 61/899,253, filed on Nov. 3, 2013.

(51) Int. Cl. G07F 17/32

(52) U.S. Cl. CPC G07F 17/3255; G07F 17/3267; G07F 17/329
USPC 463/22

(57) ABSTRACT

In an interactive character-based video game, a player is encouraged to spend more real money by providing a bonus game of chance coupled with real money spending from the player. This can be done by providing the game of chance following a purchase of virtual goods and providing a prize in the game of chance that can include real money prizes when the purchase is done using real money. This can also be done by providing a milestone bonus game of chance that includes an option to add to or increase prizes by making an optional bet of real money.

This application claims priority of U.S. provisional patent application 61/899,253, filed Nov. 3, 2013.

### TECHNICAL FIELD

The present relates to a system and method of video gaming. More particularly, the present relates to a system and method of video gaming that provides a game of chance for rewarding a player.

### BACKGROUND

Video games have come a long way since the Donkey Kong game of the early 1980's. With the advent of the internet, newer video game business models have emerged since the coin-operated video game machines found in amusement arcades and the purchasable home video game consoles/cartridges. More recent online gaming business models include pay-to-play and free-to-play gaming business models.

In the pay-to-play gaming business model, the player is required to pay an amount of money to play the video game. This model is particularly used in massively multiplayer online role-playing games (MMORPG) or social games for which the player must pay to maintain a playing account. Players assume the role of a character (often in a fantasy world or science-fiction world) and take control over many of that character's actions. MMORPGs are distinguished from single-player or small multi-player online RPGs by the number of players, and by the game's persistent world (usually hosted by the game's publisher), which continues to exist and evolve while the player is offline and away from the game. Since a single MMORPG may be played out online throughout the world, there may be several millions of subscribers to a popular MMORPG making for a potentially lucrative business for the publisher of the game.

In the free-to-play gaming business model, the player may play the video game without paying. This model was first popularly used in early massively multiplayer online games (MMO) or social games and targeted towards casual gamers, before finding wider adoption among games released by major video game publishers to combat video game piracy and high system requirements. Since games using the concept are available at no cost to players, they use other means to gather revenue, such as integrating advertisements into the game, charging small amounts of money for certain regular in-game items (like powerful bonuses, premium features or virtual goods), charging large amounts of money for certain rare in-game items or incorporating real-money gambling features.

By incorporating real money gambling features in a free-to-play video game, publishers have an increased revenue potential in contrast to only charging money for certain in-game items. Naturally, charging large amounts of money for rare in-game items may also have an interesting revenue potential in contrast to charging small amounts of money for regular in-game items. However, due to the thrill of earning real money, it has been shown that players are tempted to pay a greater amount of money for having a chance to win a certain sum of real money than they would be tempted to pay for obtaining certain in-game items. Therefore, players need to be encouraged to participate in real money gambling or, at the very least in instances where real money gambling is not available, players need to be encouraged to purchase rare in-game items while maintaining or increasing the gaming experience of the player by keeping the game fun and entertaining to play. This way, players will have the desire to play for an extended period of time and game publishers will collect increased revenues.

### SUMMARY

Applicant has been discovered that a player can be encouraged to spend more real money if a bonus game of chance offered to the player is coupled with real money spending from the player. Applicant has further been discovered that players are encouraged to spend more real money when a winning prize of the game of chance is real money. Applicant has further been discovered that players are encouraged to spend more real money when the winning prize of the game of chance is either real money for real money purchases or hard currency for hard currency purchases, and the game of chance is similarly offered for both types of purchases. In addition, it has been discovered that when a player achieves a milestone or a given goal in the game, the player can be encouraged to spend real money for playing a game of chance when the player is allowed to choose from placing a real money wager or using game environment virtual currency to play the game with payouts that corresponding include real money and virtual or in-game currency.

The present method rewards a player by offering him a game of chance at various triggered instances during the course of a video game played by the player. The skilled person reading the present description will understand that a game of chance is a game of which the outcome is impossible to predict, as it is determined by luck or randomness (i.e. a gambling game). There are various known games of chance such as a scratch card, a wheel spin, a slot machine, a bingo game. It shall be appreciated that any type or kind of game of chance may be used instead of the ones listed above.

According to one aspect, during a normal execution course of a video game in which the video game is being controlled at least in part by a player, there is provided an opportunity to the player to test his chance with a game of chance as a reward. The opportunity to the player is triggered by a predetermined game event and provides to the player a chance to win real money, win hard currency or increase his virtual wealth. The player has a chance to win real money when the predetermined game event involves spending real money or when the game of chance is activated by the player spending real money. The player has a to chance win hard currency when the predetermined game event involves spending hard currency or when the game of chance is activated by the player spending hard currency.

According to another aspect, during a normal execution course of a video game in which the video game is being controlled at least in part by a player, there is provided an opportunity to the player to test his chance with a game of chance as a reward. The opportunity to the player is triggered by a predetermined game event and provides to the player a chance to increase his personal wealth or his virtual wealth. The player has a chance to increase his personal wealth only when the predetermined game event involves spending at least part of his personal wealth or when the game of chance is activated by the player spending at least part of his personal wealth.

For clarity purposes, the following terms in the present patent application are defined as:

Real Money: Cash owned by the player outside of the game (i.e. real life money). Part of the player's personal wealth.

Hard Currency: In-game currency to purchase expensive or rare items. Hard currency is normally hard to earn and is mostly acquired through real money transactions for a large amount of money. Part of the player's personal wealth.

Soft Currency: In-game currency to make normal transactions in the game. In some games, soft currency is easy to earn and may also be acquired through real money transactions for a small amount of money. Part of the player's virtual wealth.

Wallet: The amount of in-game resources available to the player, including but not limited to hard currency, soft currency.

Scratch Card: A form of game of chance. The player reveals multiple symbols on a card. There are several different types of Scratch Cards. The rules and the odds of winning a prize can differ every time.

Wheel Spin: A form of game of chance. The player spins a wheel. When the wheel stops, the player wins the prize displayed on the wheel.

Character: An avatar that the video game player controls and through which the player interacts with the video game.

Virtual Goods: Items in the game that can be used to help the character, its progression or simply to customize the look and feel of an area of the avatar. Virtual goods may come in different shapes or form and may vary from game to game, for example: Star Power-Up, Energy Blade, Pink Dress. Part of the player's virtual wealth.

Character Experience: Experience points allow the player's character to become more powerful and/or unlock new abilities. Part of the player's virtual wealth.

Backend: A secure system on a server which receives and sends information from and to all connected games.

### BRIEF DESCRIPTION OF THE DRAWINGS

The invention will be better understood by way of the following detailed description of embodiments of the invention with reference to the appended drawings, in which:

FIG. 1 is gameplay flow chart in which a game of chance is received by a player following a virtual good purchase, according to one embodiment;

FIG. 2 is a flow chart representing the activities that take place when the game is connected to the backend system and when the player initiates a purchase of virtual goods, according to one embodiment;

FIG. 3 is a gameplay flow chart in which the game of chance is offered to the player as a reward, according to one embodiment;

FIG. 4 is a flow chart representing the activities that take place when the game is connected to the backend system and when the game of chance is offered to the player as a reward, according to one embodiment;

FIG. 5a is a block diagram representing a plurality of game servers, a backend server and a player device connected to a network, according to one embodiment;

FIG. 5b is a block diagram representing software modules of the game server and client device according to one embodiment;

FIG. 6a is a video game interface snapshot in which a virtual good purchase is offered to the player, according to one embodiment;

FIG. 6b is a video game interface snapshot in which a virtual good purchase dialog box is presented to the player, according to one embodiment;

FIG. 6c is a video game interface snapshot in which the virtual good has been purchased and a scratch card is offered to the player as a bonus, according to one embodiment;

FIG. 6d is a video game interface snapshot in which the scratch card of FIG. 6c is being played by the player, according to one embodiment;

FIG. 6e is a video game interface snapshot in which a prize of the scratch card of FIG. 6c is revealed, according to one embodiment;

FIG. 6f is a video game interface snapshot in which a bonus scratch card is awarded for buying an armour and a prize of real money is revealed after being played by the player, according to one embodiment;

FIG. 6g is a video game interface snapshot in which the scratch card prize of FIG. 6f is communicated to the player, according to one embodiment;

FIG. 7a is a video game interface snapshot in which a wheel spin is offered to the player as a bonus or reward and a jackpot winning prize of real money is shown to the player, according to one embodiment;

FIG. 7b is a video game interface snapshot in which the wheel spin is played and the winning prizes of virtual goods are shown to the player, according to one embodiment;

FIG. 7c is a video game interface snapshot in which the wheel spin is offered to the player as a bonus or reward for a given amount of real money and a jackpot winning prize of real money is shown to the player, according to one embodiment;

FIG. 7d is a video game interface snapshot in which a pay table of real money winning odds for the wheel spin is shown to the player, according to one embodiment;

FIG. 7e is a video game interface snapshot in which a real money payment confirmation dialog box for playing the wheel spin is shown to the player, according to one embodiment;

FIG. 7f is a video game interface snapshot in which the prizes of the wheel spin is shown to the player, one of the prizes being a real money prize, according to one embodiment;

FIG. 7g is a video game interface snapshot in which the prizes of the wheel spin of FIG. 7f is communicated to the player, according to one embodiment;

FIG. 7h is a video game interface snapshot in which the wheel spin is offered to the player as a bonus or reward for a given amount of real money and a jackpot winning prize of real money is shown to the player, according to one embodiment;

FIG. 7i is a video game interface snapshot in which a single prize of the wheel spin is shown to the player, the second prize of the wheel spin being a prize that the player could have won had he played with real money, according to one embodiment;

### DETAILED DESCRIPTION

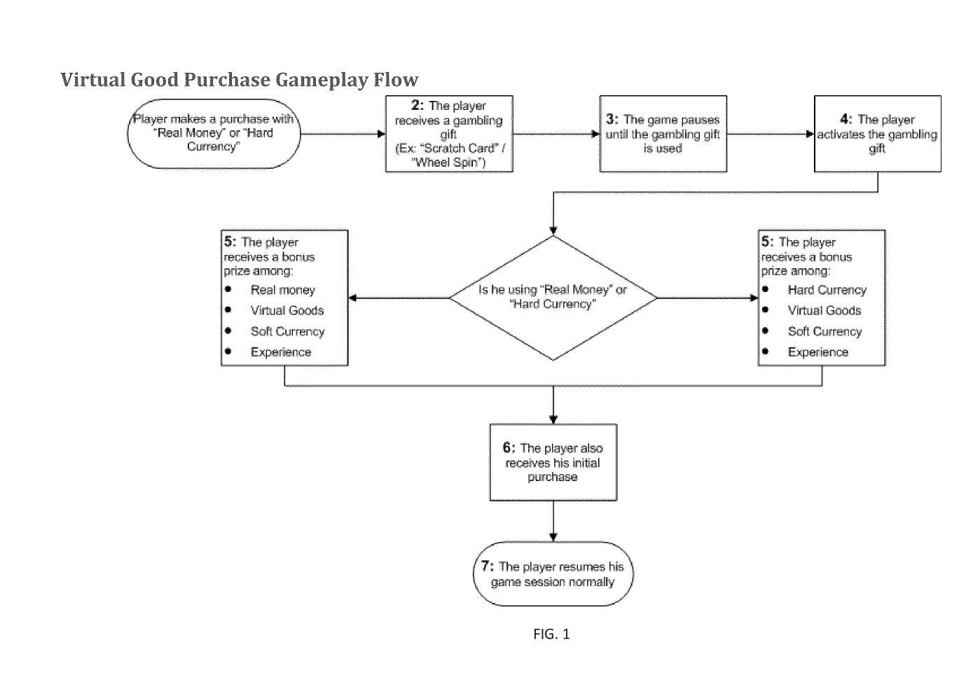

The present method of video gaming rewards a player by offering him a game of chance or game of luck at various triggered instances during the course of the game. As illustrated in FIG. 1, the game of chance may be triggered by various kinds of game events such as when the player purchases virtual goods or when the player reaches specific milestones or goals. Depending on how the game of chance is triggered and also depending on the rules of the video game, the game of chance may be offered to the player for free or at a cost.

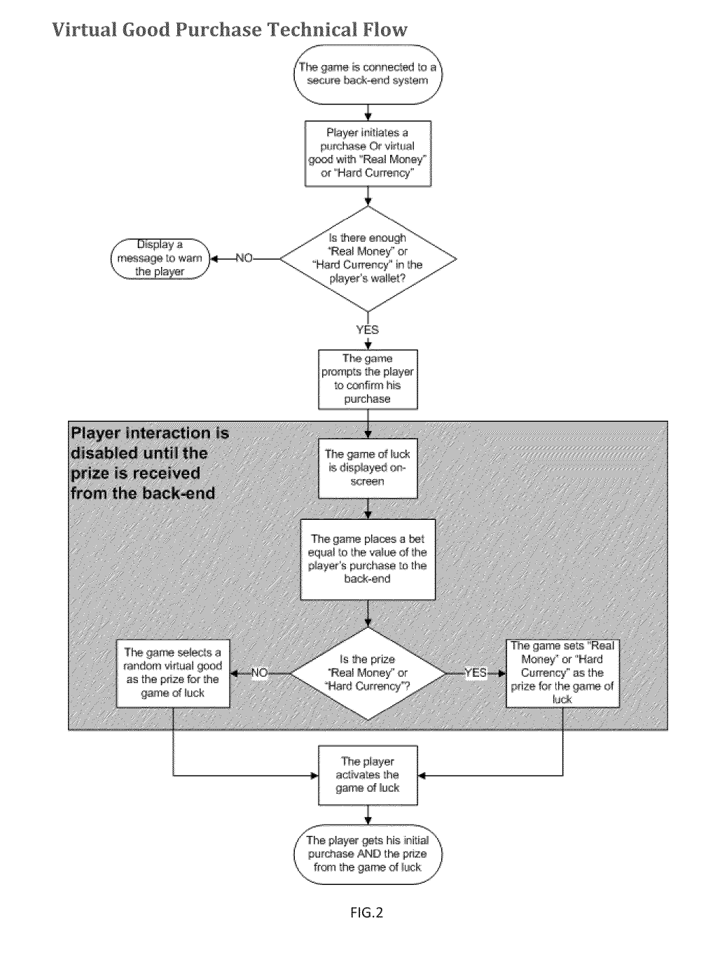

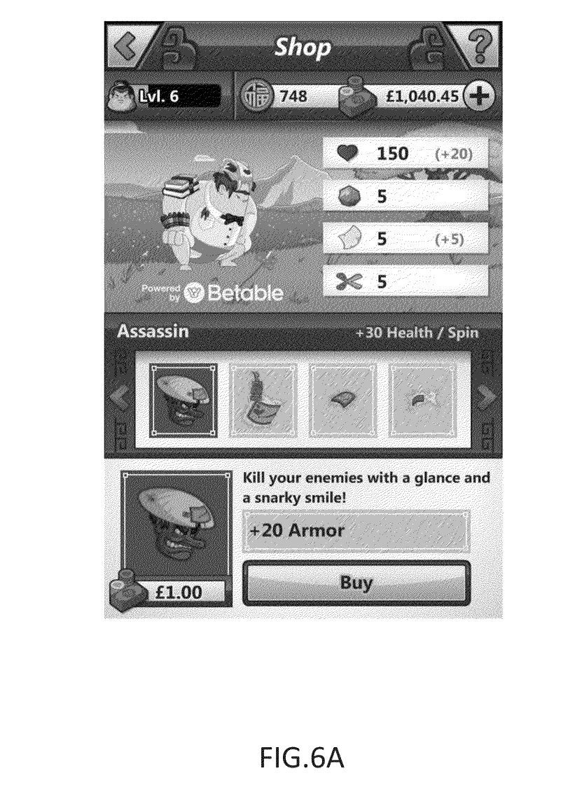

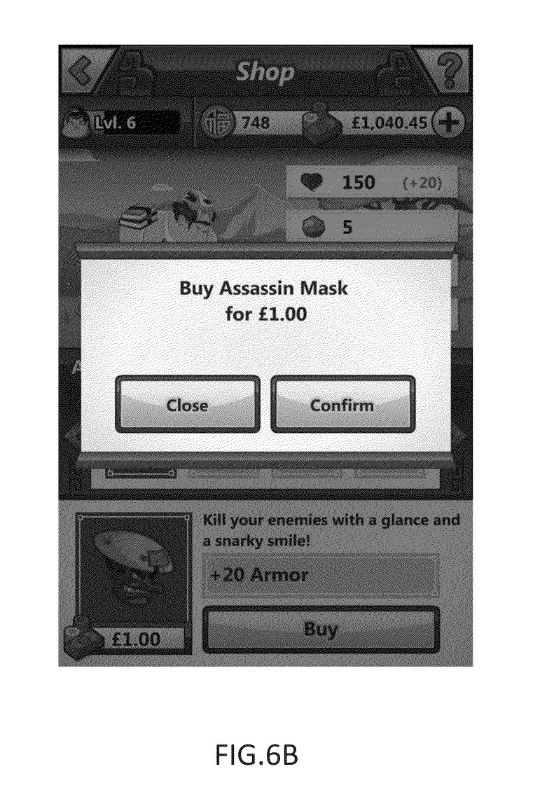

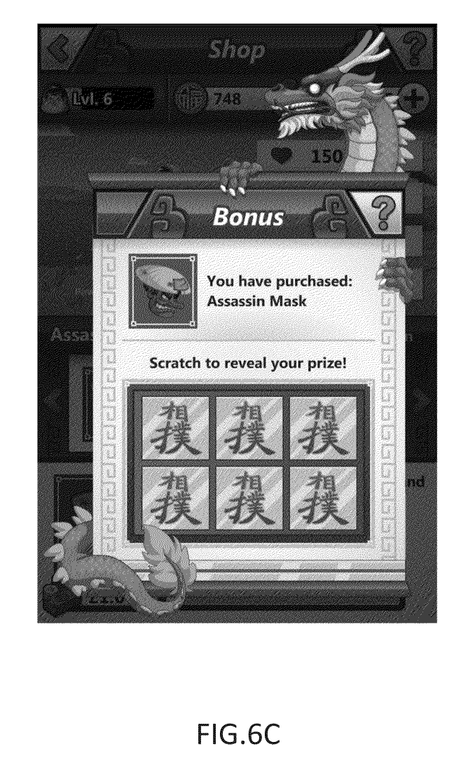

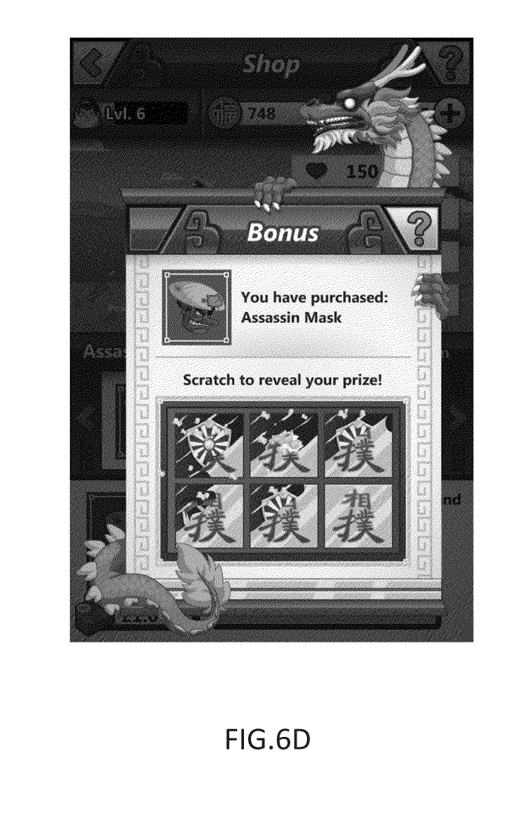

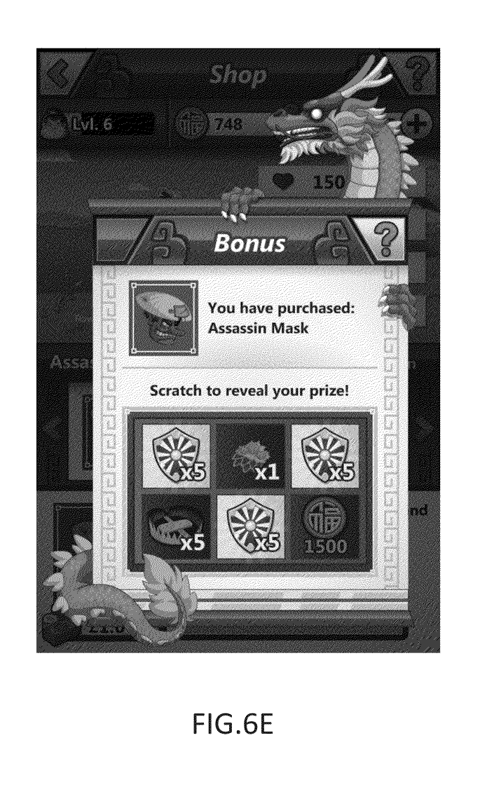

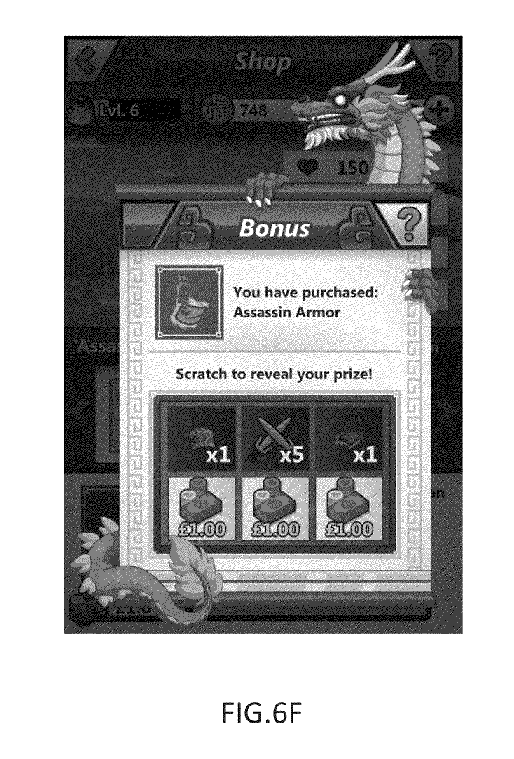

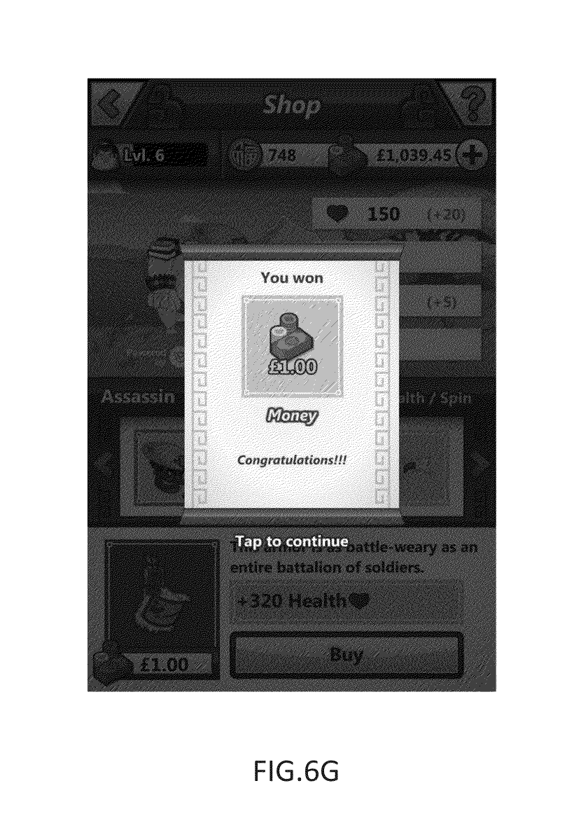

According to one embodiment, the game of chance is offered for free after the player has purchased some goods such as virtual goods in the game. In the example of FIG. 6A, in which a virtual good purchase is offered to the player, according to one embodiment, to buy +20 armor for £1 of hard currency. FIG. 6B shows the video game interface snapshot in which a virtual good purchase dialog box is presented to the player for purchase confirmation. FIG. 6C shows the exemplary video game interface snapshot in which the virtual good has been purchased, an assassin mask in this example, and a scratch card is offered to the player as a bonus. When the player purchases virtual goods by spending real money or hard currency, the player is rewarded with a game of chance as a bonus. As illustrated in FIG. 6D, the game can be a scratch and win game that the player interacts with to reveal hidden symbols. As shown in FIGS. 1 and 2, the play of the session can be paused until the game of chance is played and the prize or gift is used. FIG. 6E shows the video game interface snapshot in which a prize of the scratch card of FIG. 6C is fully revealed.

FIG. 6F shows a different video game interface snapshot in which a bonus scratch card is awarded for buying an armour and a prize of real money is revealed after being played by the player, according to another embodiment. FIG. 6G is a video game interface snapshot in which the scratch card prize of FIG. 6F is communicated to the player.

The outcome of the game of chance does not alter or influence the original purchase (i.e. the money for the originally purchased item is spent and the purchased item is transferred to the player). In essence, the game of chance is offered to the player as a reward to thank him for directly spending real money or spending real money through hard currency in the game. It is a luck-based additional reward.

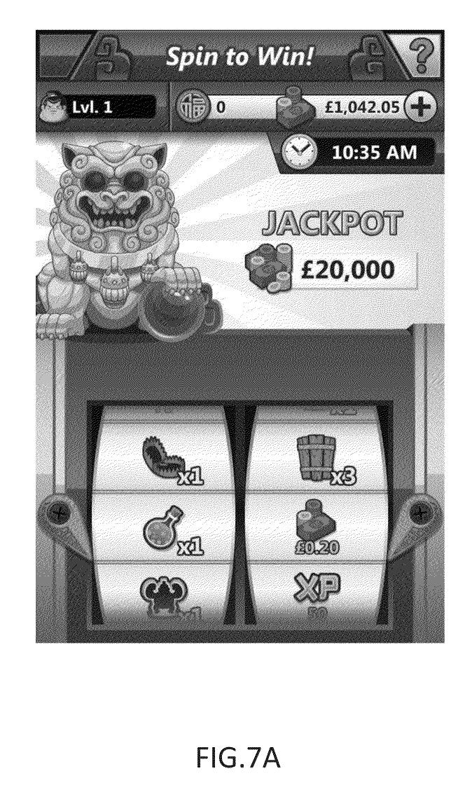

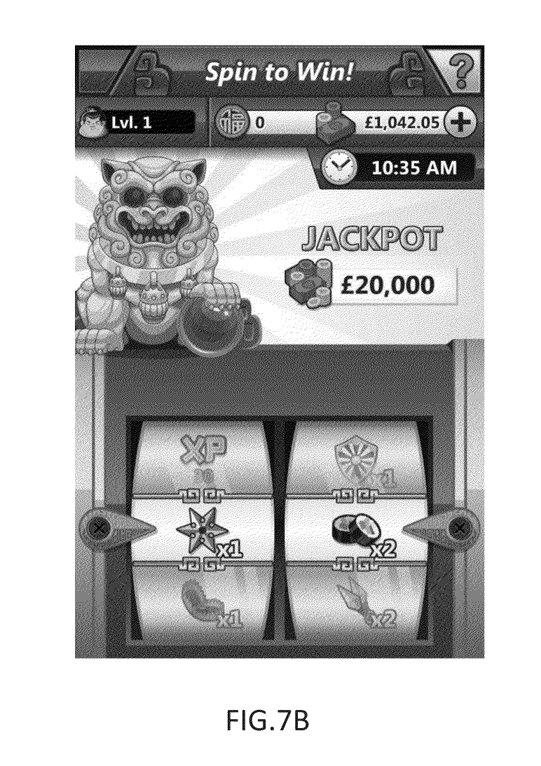

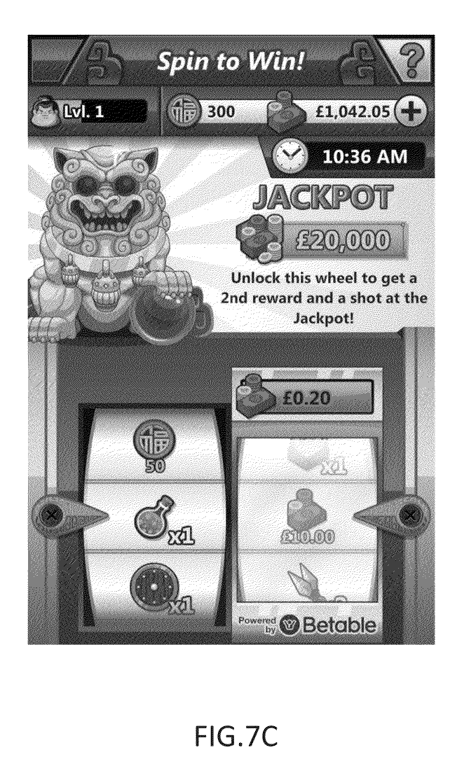

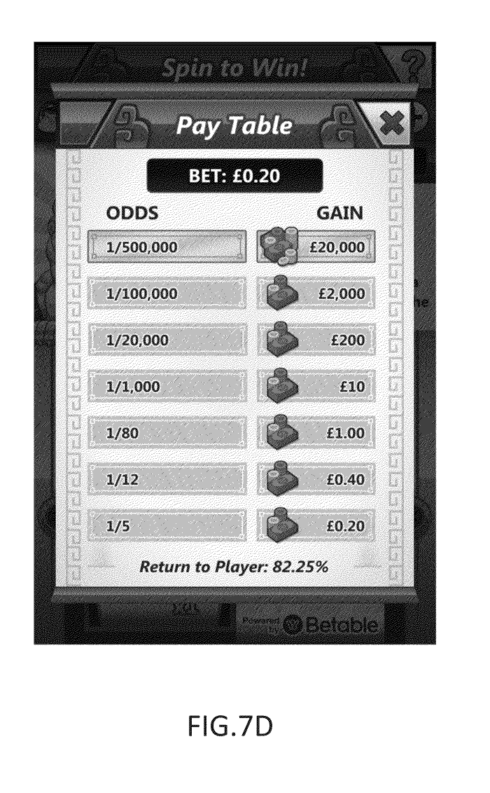

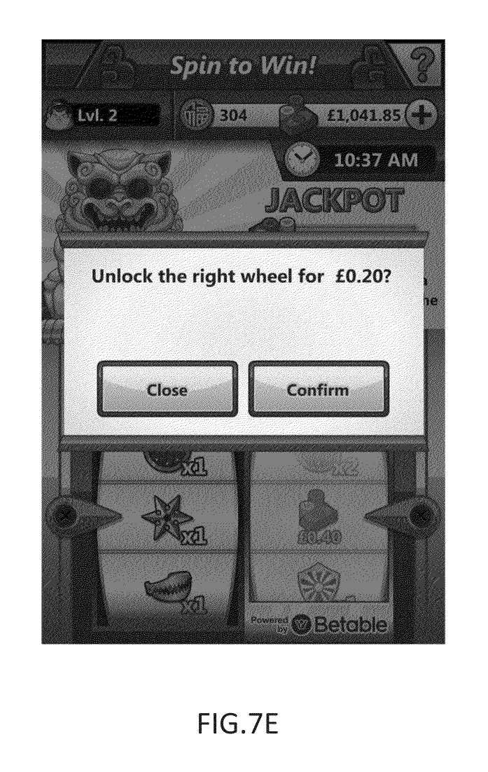

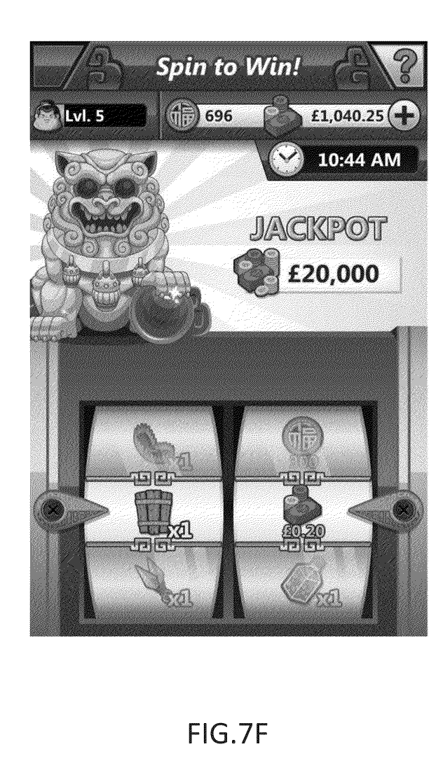

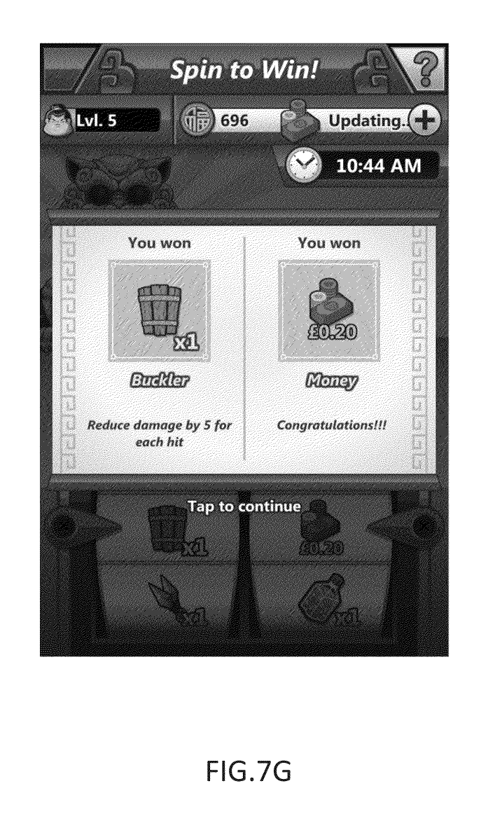

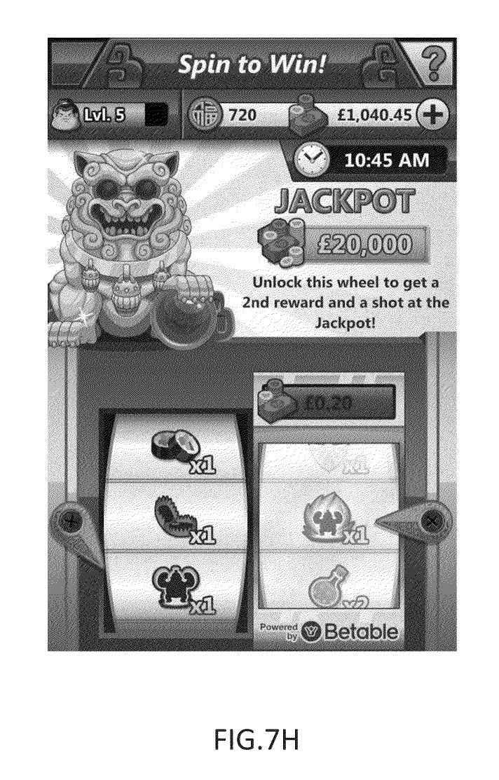

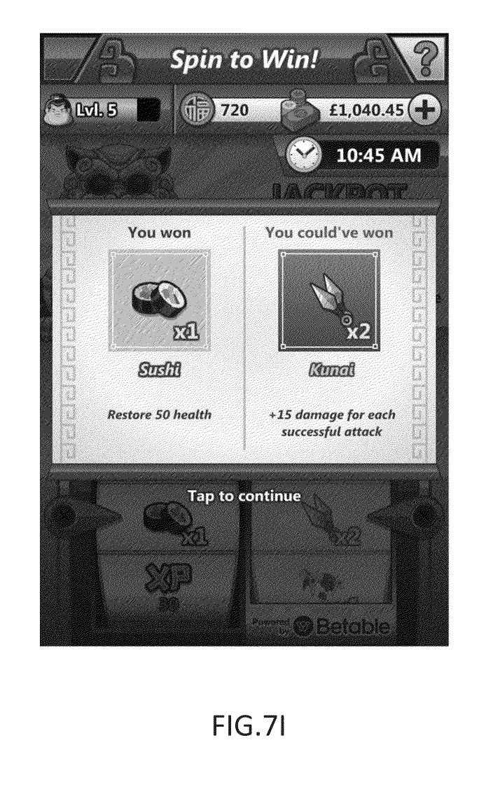

FIG. 7A is further a video game interface snapshot in which a wheel spin is offered to the player as a bonus or reward and a jackpot winning prize of real money is shown to the player. While most prizes on the wheel are virtual goods, some are real money. The jackpot prize, as shown, can be substantial, for example £20,000, than the prize awarded in the scratch and win games. FIG. 7B shows the wheel spin result and the winning prizes of virtual goods are shown to the player.

FIG. 7C is a further video game interface snapshot in which the wheel spin is offered to the player as a bonus or reward for a given amount of real money and a jackpot winning prize of real money is shown to the player. Here, the first wheel was played and a virtual good prize was won. A small real money bet is required, for example £0.20, to activate the second wheel. FIG. 7D is a video game interface snapshot in which a pay table of real money winning odds for the wheel spin is shown to the player. While the bet is small, there is a chance at a substantial prize. FIG. 7E is a video game interface snapshot in which a real money payment confirmation dialog box for playing the wheel spin is shown to the player. Once confirmed, the random selection follows, and FIG. 7F shows the video game interface snapshot in which the prizes of the wheel spin is shown to the player, one of the prizes being a real money prize, in the illustration an amount of £0.20 for which there was a chance of one in five. FIG. 7G shows the video game interface snapshot in which the prizes of the wheel spin of FIG. 7F are communicated to the player, one virtual goods prize and one real money prize.

FIG. 7H is a further video game interface snapshot in which the wheel spin is offered to the player as a bonus or reward for a given amount of real money and a jackpot winning prize of real money is shown to the player. The bet amount shown is again £0.20, and the player chooses not to pay. FIG. 7I shows the video game interface snapshot in which a single prize of the wheel spin is shown to the player, the second prize of the wheel spin being a prize that the player could have won had he played with real money. The prize that could have been won is shown as a virtual goods prize of two Kunai, a weapon in the game.

During one video game, a player decides to purchase a special weapon in the game shop for making his character more powerful. He purchases the weapon with $1 of real money. The purchase triggers a game of chance such as a scratch card. The scratch card is played and the player discovers that he wins $2 of real money. The gaming experience for the player is enhanced due to the excitement of winning the extra prize. In this game, the player spent $1 to purchase a special weapon for his character and in the process won $2. As a result, the player got the special weapon for free and made an extra $1!

According to another embodiment, the game of chance is offered at a cost when the player reaches certain milestones or goals. When the player completes specific tasks or reaches predetermined milestones, the player gets a reward and in addition, the player is offered to play the game of chance as an option. The player has the choice to test his luck for an additional bonus prize with the game of chance by spending an amount of real money or hard currency. The outcome of the game of chance does not alter or influence the initial reward for reaching the milestone or the goal.

During one video game, a player wins a fight and receives virtual goods: coins, character experience and a wooden sword. In addition, for making his character even stronger, the player is given the option to play a game of chance: a wheel spin. The player decides to play the game of chance and pays the required amount of 5 hard currency units to spin the wheel. The player spins the wheel and wins the virtual good of a prismatic shield for his character. The player is very excited since the prismatic shield is normally worth 10 hard currency units in the game shop and he got it for only 5 hard currency units! As a result, the player received the coins, the character experience, the wooden sword and in additional he received the prismatic shield by winning the fight and spending 5 hard currency units. The gaming experience for the player is increased, not only did he receive his prize for winning a fight he also won an additional prize by playing the game of chance.

There are various types of winning prizes from the game of chance. The winning prize may be a real life prize such as real money or may be a virtual prize such as hard currency, character experience, a virtual good, soft currency or another game of chance. It will be appreciated that there may be other types of real life prizes or virtual prizes that constitute the winning prize without departing from the scope of the present method and system.

According to one aspect, the winning prize type is based on the way the game of chance was initially triggered. That is, the winning prize type is based on the disbursement type that was made to trigger the game of chance, based on the disbursement type that was made by the player to play the game of chance or based on the amount of disbursement that was made by the player to play the game of chance. This is illustrated in FIG. 1.

In one video game, the game of chance is triggered when the player purchases virtual goods. When the player purchase a virtual good by spending real money or hard currency, the player is rewarded with a game of chance as a bonus. When the player initially spent real money to purchase the virtual good, the winning prize of the game of chance is one of a predetermined amount of real money or a virtual prize. Alternately, when the player initially spent hard currency to purchase the virtual good, the winning prize of the game of chance is one of a predetermined amount of hard currency or a virtual prize.

It will be appreciated that in some embodiments, the amount value of the winning prize is set according to the amount the player spent to purchase the virtual good. If the player spent a small amount (of real money or hard currency) for purchasing the virtual good, the winning prize may have a relatively small amount value. Alternatively, if the player spent a large amount (of real money or hard currency) for purchasing the virtual good, the winning prized may have relatively large amount value. Moreover, the value of the bonus prize may be influenced by the type of spending made by the player to play the game of chance. In one embodiment, if the player spent real money to play the game of luck then there are chances for the player to win a bonus prize of greater value then had he spent hard currency or virtual money.

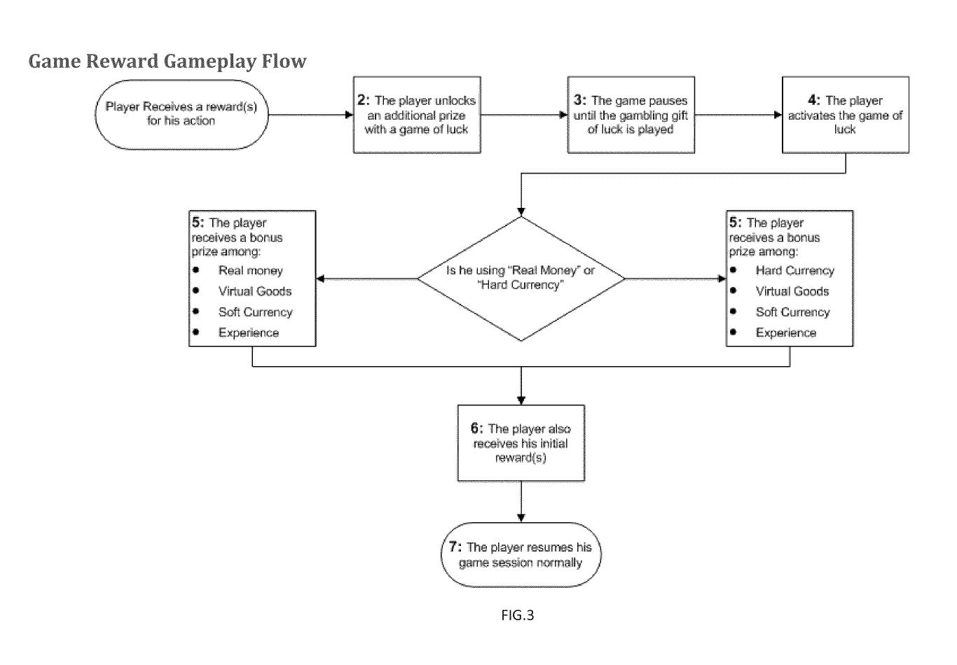

In another video game, the game of chance is triggered when the player reaches a specific milestone or goal. This is illustrated in FIG. 3. When the player completes specific tasks or reaches predetermined milestones, the player gets a reward and in addition, the player is offered to play the game of chance as an option. The player has the choice to test his luck for an additional bonus prize with the game of chance. If the player decides to play the game of chance by spending an amount of real money, the winning prize will be one of a predetermined amount of real money or a virtual prize. If the player decides to play the game of chance by spending an amount of hard-currency, the winning prize will be a predetermined amount of hard-currency or a virtual prize.

According to one embodiment, the player may select the winning prize type that he wishes to receive. For instance, if the character that the player is controlling is too weak for his liking, the player may select from a list of winning prize types the virtual prize of character experience.

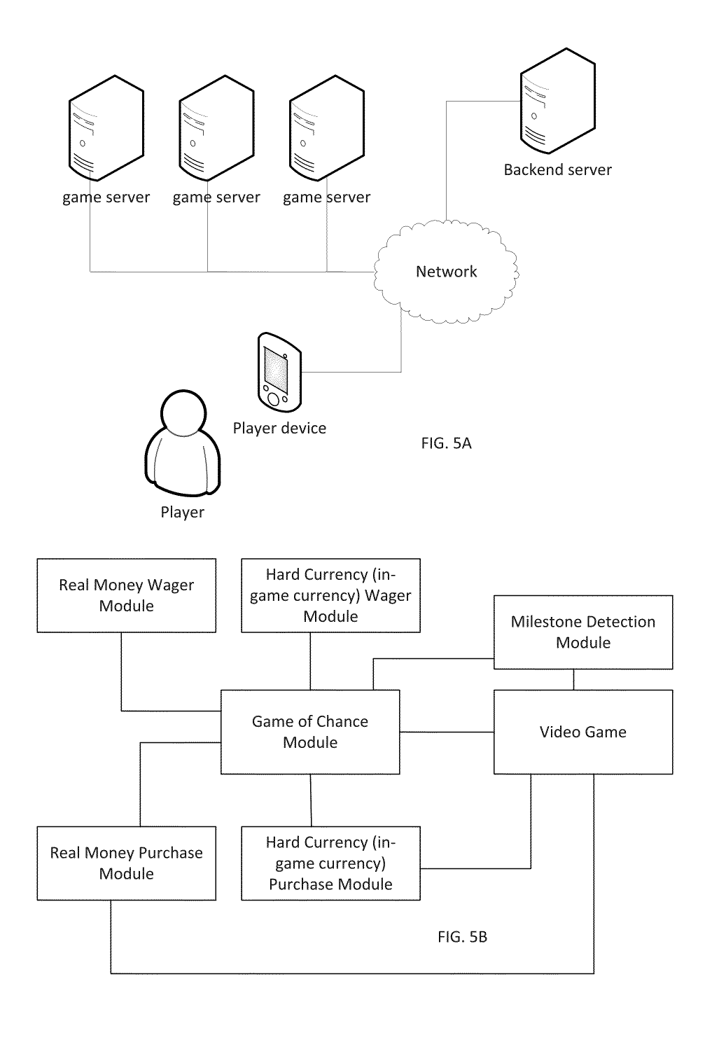

With reference to FIG. 5A, the video game system according to one embodiment has a backend server for managing financial transactions to permit players to add real money to their account or to make real money purchases. Game servers comprise one or more an interactive character-based video game modules. A player device can be a computer browser, smartphone, tablet computer or video lottery terminal, and can be connected to the game server via a network.

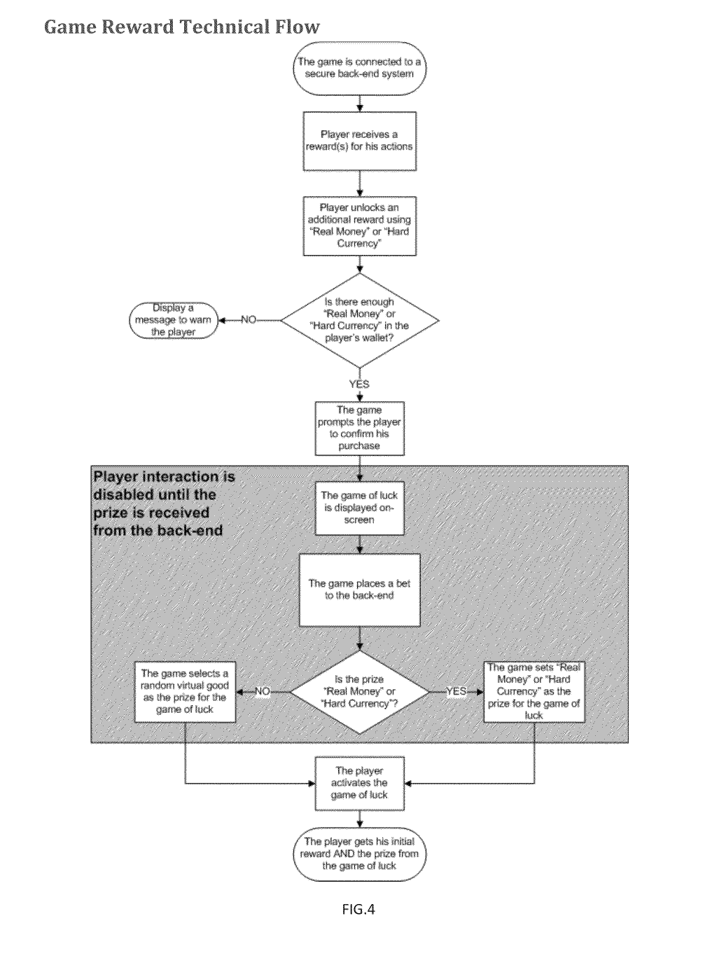

As shown in FIG. 5B, in one embodiment, a real money purchase module and a hard currency (in-game currency) purchase module are provided and configured for purchasing virtual goods for use by a player's character during the play of the interactive character-based video game using, at the choice of the player, a purchase value deducted from a hard currency account associated with the player or from a real money account associated with the player. A game of chance module is configured for playing a game of chance, separate from the interactive character-based video game, in response to purchasing virtual goods using one of the purchase modules using a wager of real money or hard currency depending on the corresponding purchase value used to make the purchase of virtual goods. The game of chance module provides to the player of the interactive character-based video game a corresponding prize including at least one prize of hard currency and excluding a prize of real money when the purchase was made using hard currency and a corresponding prize including at least one prize of real money when the purchase was made using real money, as described above with reference to FIGS. 1, 2 and 4.

A milestone detection module is also configured to detect when a player is to be rewarded for play in the interactive character-based video game. In this case, the game of chance module is configured to play a game of chance, separate from the interactive character-based video game, in response to the milestone detection module using an optional wager selected by the player, as described above and in reference to FIG. 3. The game of chance module can thus provide to the player of the interactive character-based video game a prize excluding a prize of real money when the optional wager is not made by the player and a corresponding prize including at least one prize of real money when the optional wager is made by the player.

The skilled person will understand that the game of chance may be incorporated in various types of video games such as free-to-play video games or pay-to-play video games to encourage players to spend real money in the game.

What is claimed is:

1. A video game system comprising:
an interactive character-based video game module;
a purchase module configured for purchasing virtual goods for use by a player's character during the play of the interactive character-based video game using, at the choice of the player, a purchase value deducted from a hard currency account associated with the player or from a real money account associated with the player; and
a game of chance module configured for playing a game of chance, separate from the interactive character-based video game, in response to purchasing virtual goods using the purchase module using a wager of real money or hard currency depending on the corresponding purchase value used to make the purchase of virtual goods, and providing to the player of the interactive character-based video game a corresponding prize including at least one prize of hard currency and excluding a prize of real money when the purchase was made using hard currency and a corresponding prize including at least one prize of real money when the purchase was made using real money.

2. The system as claimed in claim 1, wherein the corresponding prize includes at least one prize of virtual goods, soft currency and experience.

3. The system as claimed in claim 1, wherein the game of chance is a scratch card.

4. The system as claimed in claim 1, wherein the game of chance is a wheel spin.

5. A video game system comprising:
an interactive character-based video game module;
a milestone detection module configured to detect when a player is to be rewarded for play in the interactive character-based video game;
a game of chance module configured for playing a game of chance, separate from the interactive character-based video game, in response to the milestone detection module using an optional wager selected by the player, and providing to the player of the interactive character-based video game a prize excluding a prize of real money when the optional wager is not made by the player and a corresponding prize including at least one prize of real money when the optional wager is made by the player.

6. The system as claimed in claim 5, wherein the optional wager consists of a real money wager.

7. The system as claimed in claim 5, wherein the optional wager comprises one of a real money wager and a hard currency wager.

8. The system as claimed in claim 5, wherein, when the optional wager is selected, the game of chance module is configured to play two games, a first offering prizes of virtual goods, soft currency and/or experience, and a second offering prizes including real money prizes.

9. The system as claimed in claim 5, wherein, when the optional wager is not selected, the game of chance module is configured to play two games, a first offering prizes of virtual goods, soft currency and/or experience, and a second showing prizes including real money prizes that could have been won had the optional wager been made.

10. The system as claimed in claim 5, wherein the corresponding prize includes at least one prize of virtual goods, soft currency and experience.

11. The system as claimed in claim 5, wherein the game of chance is a scratch card.

12. The system as claimed in claim 5, wherein the game of chance is a wheel spin.

13. The system as claimed in claim 8, wherein the game of chance is a wheel spin.

14. The system as claimed in claim 9, wherein the game of chance is a wheel spin.
